(19) United States
(12) Patent Application Publication
(10) Pub. No.: US 2009/0039068 A1
(43) Pub. Date: Feb. 12, 2009

(54) ELECTRIC CURRENT CONDUCTION SYSTEM FOR APPLIANCE

(75) Inventor: Rodney Boutwell, Springfield, TN (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 11/836,935

(22) Filed: Aug. 10, 2007

(51) Int. Cl. H05B 1/00

(52) U.S. Cl. 219/220

(57) ABSTRACT

An appliance is provided with an electric current conduction system. The appliance includes a main body portion including an interior cavity, and a door mounted for movement between an open position and a closed position. A driven component is coupled to the door and disposed at least partially exterior of an outer face thereof. In one example, the driven component is a light. An electric current conduction system includes a first conductor connected to the main body a second conductor connected to the door and configured to selectively engage the first conductor based upon the position of the door. Electric current is conducted between the first and second conductors when the first conductor is enaged with the second conductor. The driven component is operatively connected to the second conductor, such that electric current is conducted between the main body portion and the driven component for driving the driven component.

### RELATED APPLICATIONS

Not Applicable.

### FIELD OF THE INVENTION

The present invention relates generally to an electric current conduction system for an appliance, and more particularly to an electric current conduction system for selectively driving a driven component of an appliance.

### BACKGROUND OF THE INVENTION

Several types of appliances, such as ranges, dishwashers, refrigerators, freezers, etc., may include various driven components that are selectively driven via automatic or manual controls. Electric current is often supplied to the driven components by multitudes wires routed variously throughout the appliance, many of which must be connected by way of wire blocks, junctions, or the like. Often, where a driven component is located on an appliance door, the electrical supply wires must also be routed through the door hinges or in other inconvenient manners so as not to be exposed when the door is opened. Further, the electrical supply wires and/or wire blocks can become strained or even damaged due to the repetitive opening of the appliance door, whereupon the driven component may function intermittently or not at all. Accordingly, there is a need in the art for a new electric current conduction system.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with an aspect of the present invention, an appliance having an electric current conduction system is provided. The appliance includes a main body portion including an interior cavity having an opening, and a door mounted for movement between an open position permitting access to the interior cavity and a closed position having the door extend across the opening. The door is at least partially bounded by an outer face. The appliance also includes a driven component coupled to the door and disposed at least partially exterior of the outer face. The appliance also includes an electric current conduction system, including a first conductor connected to the main body a second conductor connected to the door. The second conductor is configured to selectively engage the first conductor based upon the position of the door, and electric current being conducted between the first and second conductors only when the first conductor is engaged with the second conductor. The driven component is operatively connected to the second conductor, such that electric current is conducted between the main body portion and the driven component for driving the driven component only when the first conductor is engaged with the second conductor.

In accordance with another aspect of the present invention, an electric current conduction system for an appliance is provided. The electric current conduction system includes means for receiving electric current from a supply line at supply line voltage, means for reducing the voltage of the electric current received by the means for receiving to a voltage less than the supply line voltage, and a driven component. The electric current conduction system also includes a first conductor configured to be coupled to a main body of an appliance and operatively connected to the means for reducing, and a second conductor electrically connected to the driven component. The second conductor is configured to be coupled to a door of an appliance so as to selectively engage and disengage the first conductor based upon a position of the door. The reduced voltage electric current is conducted between the first conductor and the driven component only when the first conductor is engaged with the second conductor.

In accordance with another aspect of the present invention, an appliance having an electric current conduction system is provided. The appliance includes a main body portion including an interior cavity having an opening, and a door mounted for movement between an open position permitting access to the interior cavity, and a closed position having the door extend across the opening. A handle is coupled to the door and at least partially disposed exterior of the door. The appliance also includes an electric current conduction system, including a first conductor connected to the main body and a second conductor connected to the door. The second conductor is configured to selectively engage and disengage the first conductor based upon the position of the door, and electric current is conducted between the first and second conductors only when the first conductor is engaged with the second conductor. The appliance also includes a light coupled to the handle and operatively connected to the second conductor for receiving electric current for driving the light.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of an oven having an oven door shown in a closed position in accordance with an aspect of the present invention;

FIG. 2 is similar to FIG. 1, but shows the oven door in an open position;

FIG. 3 is a perspective view of only the oven door showing an example driven component in accordance with another aspect of the present invention;

FIG. 4A illustrates an example electric current conduction system with the oven door in an open position in accordance with an aspect of the present invention;

FIG. 4B is similar to FIG. 4A, but shows the oven door in a closed position;

FIG. 5 illustrates another example electric current conduction system with the oven door in an open position in accordance with another aspect of the present invention;

FIG. 6A illustrates yet another example electric current conduction system with the oven door in an open position in accordance with an aspect of the present invention; and

FIG. 6B is similar to FIG. 6A, but shows the oven door in a closed position.

### DESCRIPTION OF EXAMPLE EMBODIMENTS

An example embodiment of a device that incorporates aspects of the present invention is shown in the drawings. It is to be appreciated that the shown example is not intended to be a limitation on the present invention. For example, one or more aspects of the present invention can be utilized in other embodiments and even other types of devices.

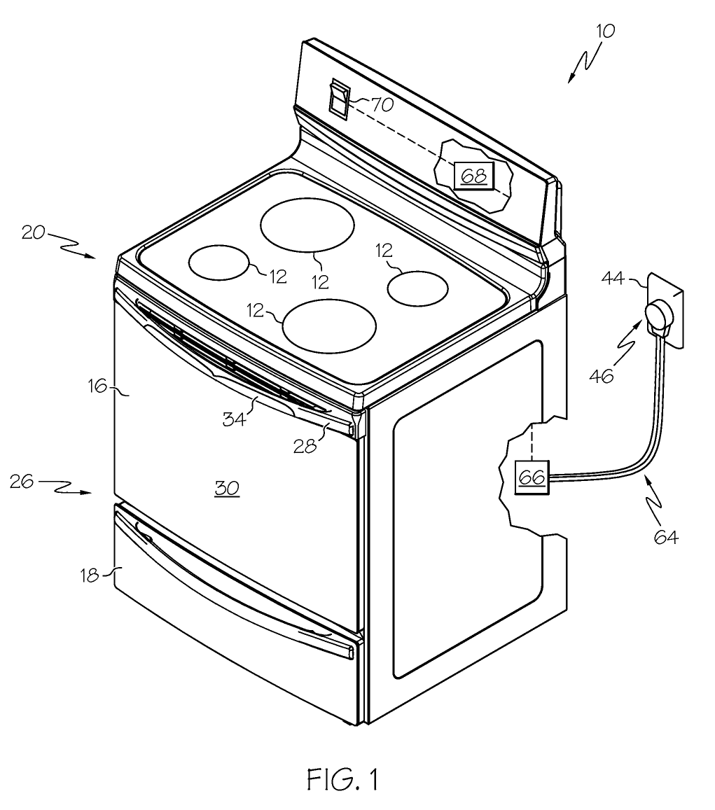

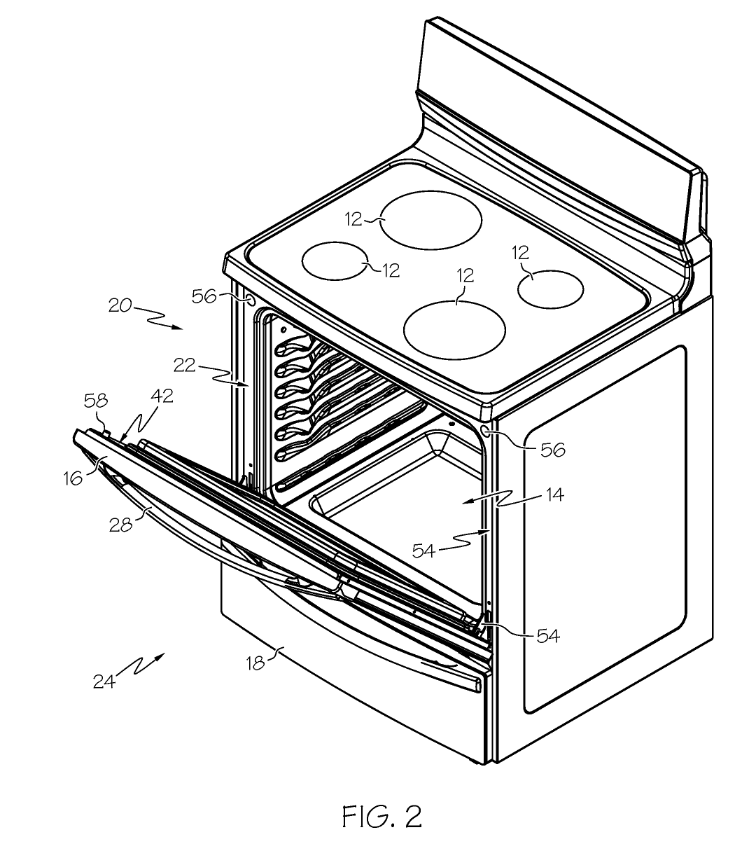

Turning initially to FIG. 1, an example appliance 10 having an electric current conduction system is illustrated in accordance with an aspect of the present invention. As shown, the appliance 10 can be a cooking range, though various other appliances having doors can also be used. The range 10 can include various common elements, such as one or more burners 12 located on a top surface thereof, an internal oven cavity 14 (see FIG. 2) selectively closed by an oven door 16, and/or a warming/storage drawer 18. As can be appreciated, any of the burners 12 and/or the oven cavity 14 can be electric or gas powered. In addition or alternatively, the range 10 can include only an oven cavity 14 (e.g., a stand-alone oven).

As shown in FIG. 2, a main body portion 20 of the range 10 includes the oven cavity 14. The oven cavity 14 is bounded on five sides by walls, and has an opening 22 extending through the sixth side. The opening 22 is selectively opened and closed by the oven door 16, which is pivotally mounted to the main body portion 20 for movement between an open position 24 generally permitting access to the oven cavity 14, and a closed position 26 having the door 16 extend across the opening 22. As can be appreciated, the door 16 can be partially or completely open when in the open position 24. Further, when in the closed position 26, the door 16 can partially or completely close off the opening 22 so as to provide a thermal barrier between the oven cavity 14 and the exterior environment. Additionally, the oven door 16 can include a handle 28 to enable a user to move the oven door 16 between the open and closed positions 24, 26. As shown, the handle 28 can be coupled to an outer face 30 of the oven door 16, though it can also be disposed at various other locations.

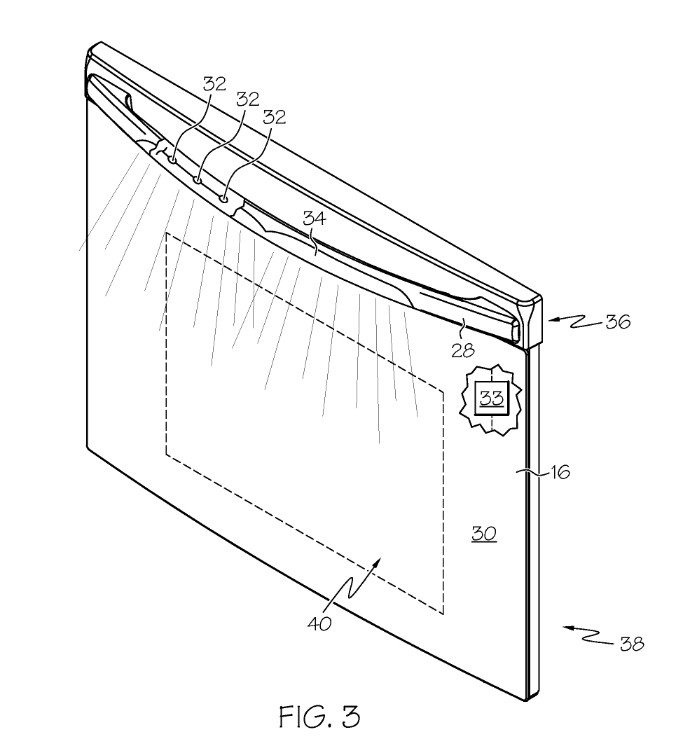

Turning now to FIG. 3, an example driven component can be coupled to the oven door 16 so as to move therewith. The driven component can include various elements adapted to provide various features and functions to the range 10. In one example, the driven component can include a light 32 for illuminating the exterior of the oven door 16. Additionally, the driven component can be disposed within the door 16, or can be disposed at least partially exterior of the outer face 30. For example, as shown, the light 32 can be mounted within the oven door handle 28 and can emit light through a light permeable portion 34 of the handle 28. For example, the light permeable portion 34 can be translucent or transparent, and can include various features to augment the emitted light, such as coloration, surface features, reflectors, lenses, etc. Further still, such features for augmenting the emitted light can even be selectively modified over time to provide increased functionality and/or customization. The light permeable portion 34 can be removably or non-removably attached to the handle 28 in various manners, such as by way of fasteners, adhesive, a snap connection, an interference fit, welding, etc. In addition or alternatively, the light permeable portion 34 can be formed with a portion of the handle 28. Additionally, the handle 28 can include a removable portion for repair or replacement of the light(s) 32 over time. For example, the light permeable portion 34 can be removed from the handle 28 for servicing the light(s) 32, though the handle 28 can also include various other removable portions.

The light 32 can include various types and styles of devices for emitting light. For example, the light 32 can include incandescent, fluorescent, and/or halogen bulbs, light emitting diodes (LED's), electroluminescent devices, etc. The door 16 can include one or more light(s) 32 arranged in various manners about the handle 28. Generally, by the nature of the electric current conduction system described here, the light(s) 32 can be low voltage lights, as it can be beneficial to use low voltage light(s) 32 that comply with the Safety Extra Low Voltage (SELV) standard promulgated by the International Electrotechnical Commission (IEC) to provide increased safety for an end user of the appliance 10. For example, the light(s) 32 can be adapted to operate on a voltage within the range of 0 volts and 50 volts, though other voltage ranges can also be used. Additionally, the light(s) 32 can be adapted to operate on either AC and/or DC current. The light(s) 32 can also be adapted to emit only one intensity of light, or even variable intensities of light.

The light(s) 32 can be arranged to emit light in various directions for illuminating various things. As shown in FIG. 3, the handle 28 can be coupled to the oven door 16 generally about an upper portion 36 thereof, and the light(s) 32 can be arranged within the handle 28 so as to emit light generally downward towards a lower portion 38 of the door 16. Thus, the light permeable portion 34 of the handle 28 can be located towards the underside of the handle 28. As such, the light(s) 32 can emit light directed generally downwards across the outer face 30 of the oven door 16, and/or towards the floor. In such a configuration, the light(s) 32 can provide a night light feature to the appliance 10 so as to partially illuminate a portion of a dark room, such as a kitchen at night. In another example, the light(s) 32 can be adapted to emit light directed inwards towards the oven cavity 14 by way of a window 40 (shown in phantom) or the like on the oven door 16 to enable a user to better view items being cooked or stored in the oven cavity 14.

Though the light(s) 32 have been described as being coupled to the handle 28, the light(s) 32 can be coupled to various other portions of the oven door 16. For example, the light(s) 32 can be coupled to various portions of the outer face 30 of the oven door 16, or can even be coupled to an inner face 42 (see FIG. 2) of the door 16 for illuminating the internal oven cavity 14. In addition or alternatively, the driven component can also include various other elements aside from lights. In one example, the driven component can include a fan (not shown) for exhausting air from the oven cavity 14, or for providing a convection cooking airflow within the oven cavity 14. In another example, the driven component can include a control device (not shown) for controlling operation of the appliance 10, such as the surface burners 12 or internal oven baking cavity 14. The control device can include various user operable controls, visual displays, audio components, etc. In yet another example, the driven component can include a dispenser or the like, such as an ice and water dispenser on a refrigerator or freezer. In still yet another example, the driven component can include a sensor 33 for sensing a condition within, or even outside of, the oven cavity 14, though the sensor 33 can also be separate from the driven component(s). For example, the sensor 33 can include a temperature sensor (e.g., an internal temperature or an outside ambient temperature), an ambient light sensor, a proximity sensor, a motion sensor, a touch sensor, a sound sensor, door sensor, etc. Though the sensor 33 is shown located within the oven door 30 in the example illustration of FIG. 3, it is to be appreciated that the sensor 33 can be located at various internal or external positions of the appliance 10.

Of course, various combinations of driven components can also be included. For example, the driven components can include a light and a sensor 33, such as an ambient light sensor (e.g., a photoresistor, photoconductor, photocell, phototransistor, or the like). Thus, when the ambient light sensor detects a relatively dark ambient lighting condition around the appliance 10, such as may occur during night, the light(s) 32 can be caused to operate as an automatic night-light or the like. In another example, the driven components can include a light 32 and a proximity sensor for detecting the presence of a user near the appliance 10, whereupon the light 32 can be activated in response to the approach of the user, and/or deactivated as the user walks away. Indeed, the night-light can operate in an on-off fashion, or can even provide a variable amount of light dependent upon the conditions detected by the sensor. For example, the light 32 can be caused to brighten as the ambient light intensity decreases (e.g., brighten at night, or vice-versa), or caused to brighten due to the detected approach of a user, or vice-versa. In addition or alternatively, the light(s) 32 can be on a timer, and/or can include various other combinations of features (e.g., brightening, dimming, changing colors, pulsating, etc.). Of course, the sensor 33 can be adapted to at least partially, or even completely, control the driven component in a manner fitting of the driven component (e.g., dim a light 32, turn on/off a fan, operate or activate a control system, actuate an ice or water dispenser, etc.). Further still, the sensor 33 can be located variously about the appliance 10, such as on the door 16, the handle 28, within the appliance cavity 14, on upper display panel of the appliance 10, on the control circuitry 68, etc.

Example electric current conduction systems will now be described. In short summary, the electric current conduction system provides power from a supply source, such as a standard electrical outlet 44 by way of an electric plug 46 (see FIG. 1), via control circuitry or power components of the appliance 10, and to the driven component. Of course, the standard electrical outlet 44 and/or electric plug 46 can be configured to operate on various voltages and currents, such as standard 110V or 220V AC, though various other AC and DC voltages are also contemplated. Various example electric current conduction systems will now be described, with the understanding that each example may or may not incorporate elements of the other examples.

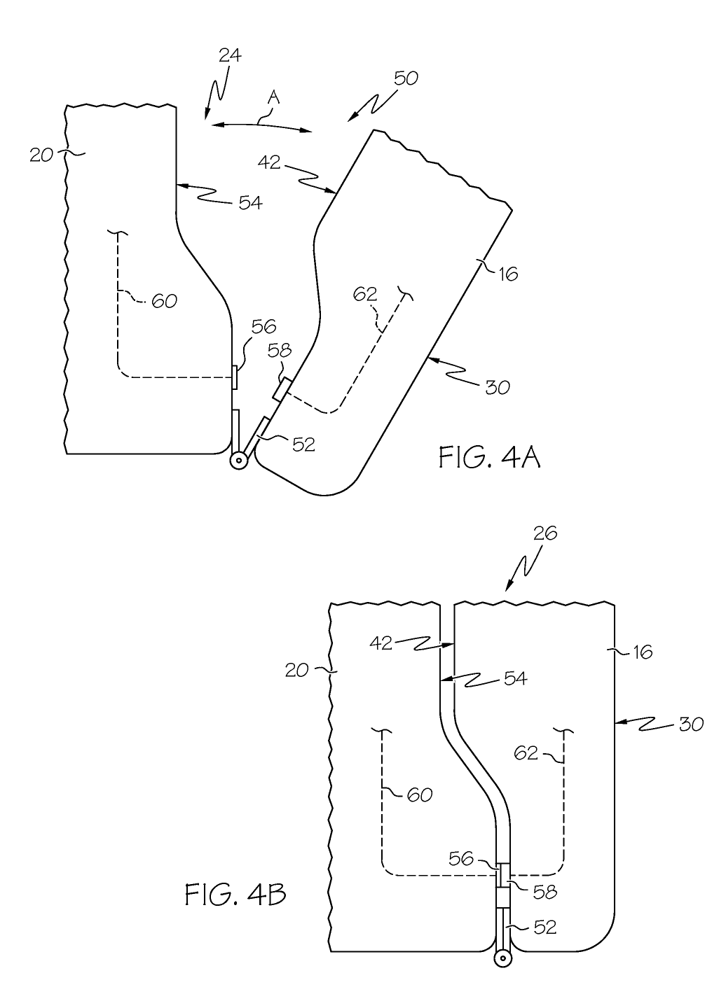

Turning now to FIGS. 4A-4B, a first example electric current conduction system 50 will now be described. As previously discussed, the oven door 16 is pivotally attached to the main body portion 20 by way of a hinge 52 or the like for movement along the direction of arrow A. As shown in FIG. 4A, which is a detail view of the connection between the oven door 16 and the main body portion 20, the oven door 16 is in an open position 24 such that the inner face 42 of the door 16 is spaced a relatively large distance from the chassis flange 54 of the main body portion 20. Alternatively, as shown in FIG. 4B, the oven door 16 is in a closed position 26 such that the inner face 42 of the door 16 is spaced a relatively small distance, adjacent to, and/or in abutment with the chassis flange 54. Of course, various insulators, gaskets, spacers, or the like can be located between the door 16 and the main body portion 20.

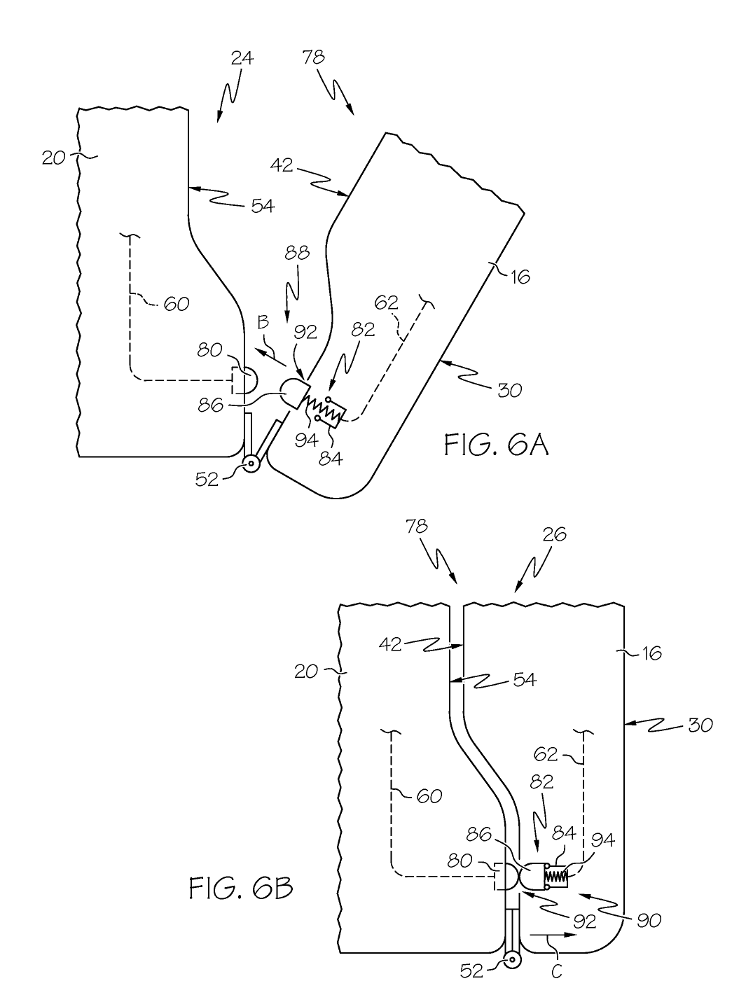

One portion of the electric current conduction system is carried by the oven door 16, and another portion is carried by the main body portion 20. For example, a first conductor 56 is connected to the main body portion 20, while a second conductor 58 is connected to the oven door 16 and is configured to selectively engage the first conductor 56 based upon a position (e.g., open 24 or closed 26) of the oven door 16. In the shown first example conduction system 50, the first and second conductors 56, 58 can be generally flat make-and-break contact conductors that are capable of conducting electrical current when in direct contact with each other. Of course, though shown as generally flat contacts, either or both conductors 56, 58 can have various surface features, such as surface textures, curved surfaces (e.g., see FIGS. 6A-6B), etc. Additionally, the first and second conductors 56, 58 can include various electrically conductive materials, such as various metals, etc.

Thus, as shown in FIG. 4A, when the oven door 16 is in the open position 24 and the inner face 42 is moved away from the chassis flange 54, the first conductor 56 is separated from the second conductor 58 and no electric current can flow therebetween. However, when the oven door 16 is in the closed position 26, as shown in FIG. 4B, the inner face 42 is generally adjacent to the chassis flange 54 and the first conductor 56 is in contact with the second conductor 58 such that electric current is able to flow therebetween. Thus, when the first and second conductors 56, 58 are in contact, electric current can flow from the power supply (e.g., outlet 44 and plug 46), through the appliance 10, and to the driven component, such as the light 32, for driving the driven component. In the shown example, the first conductor 56 is engaged with the second conductor 58 so as to conduct electric current therebetween only when the door 16 is in the closed position 26, though it is contemplated that the conductors 56, 58 can be engaged depending upon other positions of the door 16. Additionally, the first conductor 56 can be operatively connected, either directly or indirectly, to the power supply, such as through a first electrical line 60, and the driven component (e.g., light 32, see FIG. 3) can be operatively connected, either directly or indirectly, to the second conductor 58, such as through a second electrical line 62. Therefore, usage of the above described first and second conductors 56, 58 eliminates the need for a direct and continuous electrical line or cable between the power supply and the driven component.

As stated previously, the electric current conduction system 50 can include various other elements. In one example, the system 50 can include a temporary power backup system (not shown), such as a battery backup, capacitor, or the like. Thus, even when the oven door 16 is moved to the open position 24 and the flow of electric current is interrupted between the first and second contacts 56, 58, the temporary power backup system can continue to supply power to the driven component until the first and second contacts 56, 58 are re-engaged. Such a power backup system can be beneficial where the driven component includes a control system, sensors, or the like.

In another example, as shown in FIG. 1, the system 50 can include means for receiving 64 electric current from a supply line (e.g., outlet 44 or plug 46) at supply line voltage. Commonly, supply line voltage may be 110V or 220V AC, though other supply line voltages can also be provided, including various DC supply line voltages. Further, the electric current conduction system 50 can include means for reducing 66 the voltage of the electric current received by the means for receiving 64 to a voltage less than the supply line voltage. The means for reducing 66 can include various electrical or electromechanical mechanisms or methodologies that can operate actively or passively. For example, the means for reducing 66 can include various relays, resistors, diodes, transformers, solid state technology (e.g., transistors or the like), voltage dividers, voltage regulator, etc.

For example, as discussed previously, it can be beneficial to operate the driven component at a low voltage, such as within the SELV standard. Thus, the means for reducing 66 can reduce the electric current to within the range of approximately 0 volts to 50 volts AC. Alternatively, if using DC, the means for reducing 66 can reduce the electric current to within the range of approximately 0 volts to 50 volts DC. In either event, the reduced voltage electric current can be thereafter conducted between the first and second conductors 56, 58 when in contact with each other. As shown in FIG. 1, the means for reducing 66 can be connected directly to the first conductor 56, or can be indirectly connected to the first conductor 56 by way of various other power elements (not shown) or even control circuitry 68 of the appliance 10. Further still, the system 50 can include a switch 70 or the like for selectively interrupting the conduction of electric current to the driven component. The switch 70 can be an on-off switch, or can even provide a dimming feature. The switch 70 can be directly connected to any or all of the first conductor 56, second conductor 58, or driven component for manually interrupting the power supply to the driven component, or it can also be indirectly connected to the driven component, such as through control circuitry 68 of the appliance 10 for automatic or semi-automatic control. In one example, the switch 70 can be located on an upper display panel of the appliance 10 (as shown in FIG. 1), or can even be located on the handle 28. In addition or alternatively, the switch 70 can include a door sensor (not shown) adapted to detect whether the door 16 is in the open or closed positions 24, 26. The switch 70 can operate independent of, or even with, the sensor 33 for providing greater user control of operation of the driven component. For example, where the driven component includes a light 32, the switch 70 can even be coupled with a light sensor (not shown) to selectively operate the light 32 when a dark condition is detected, as previously described herein.

Various other electrical conduction systems will now be described. Identical or similar elements to those of the first system 50 described above will be indicated with the same numbers, and will not be discussed further herein, while different elements will be numbered accordingly and discussed below. Of course, any of the various other electrical conduction systems described below can include any of the features described above, or even new features.

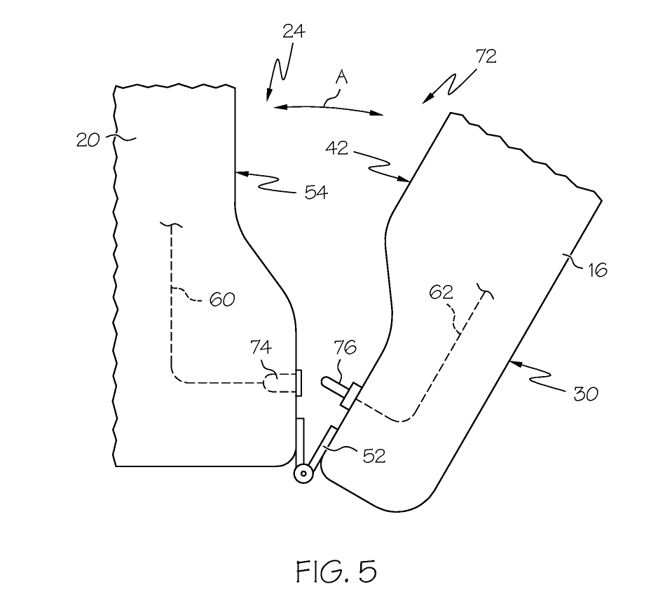

Turning to the example shown in FIG. 5, a second electric current conduction system 72 is shown. The second system 72 is similar to the first system 50, though the generally flat contacts of the first and second conductors 56, 58 have been replaced by receptacle 74 and probe 76 elements. Specifically, the receptacle 74 replaced the first conductor 56, and the probe 76 replaces the second conductor 58, though the elements can be reversed. When the door 16 is in the open position 24 (as shown) the probe 76 will be separated from the receptacle 74 and electric current flow to the driven component will be interrupted. However, when the door 16 is moved to the closed position (not shown), the probe 76 will engage and be received by the receptacle 74, as will be apparent to one of ordinary skill in the art. In such a case, generally only the probe 76 will extend or project a distance from the door 16, while the receptacle 74 will remain concealed within the chassis flange 54. Such a design can be beneficial to inhibit an end user from tampering with the electric current conduction system 72.

Turning now to the example shown in FIGS. 6A-6B, a third electric current conduction system 78 will now be described. The third system 78 is similar to the first system 50, with the exception that one or both of the first and second conductors include movable elements. For example, as shown in FIG. 6A, the oven door is in the open position 24, and the first and second conductors 80, 82 are separated a distance from each other such that no electric current can flow therebetween. The first conductor 80 is illustrated as being generally fixed to the chasses flange 54, though it can also include movable elements. The second conductor 82 includes a base member 84 generally fixed to the oven door 16, and an actuator member 86 movable relative to the base member 84 and the door 16. The actuator member 86 is movable between a first position 88 (e.g., an extended position along the direction of arrow B) and a second position 90 (e.g., a retracted position along the direction of arrow C). As shown in the first extended position 88, the actuator 86 can extend partially or completely though a hole 92 or aperture of the door 16, though the actuator 86 can also be contained entirely within the door 16. The actuator member 86 can be coupled to the base member 84 by way of a resilient element, such as a spring 94 or the like that can resiliently bias the actuator member 86 towards the first position 88. However, when the actuator member 86 is in the first position 88, it is separated a distance from and/or otherwise not in electrical contact with the base member 84. Thus, the driven component cannot receive electric current when the actuator member 86 is in the first position 88.

However, as the oven door 16 is moved to the closed position 26, as shown in FIG. 6B, the first conductor 80 located on the main body portion 20 will contact the actuator member 86 and force it towards the retracted position 90 against the bias force of the spring 94. When the actuator 86 reaches the retracted position 90, such as when the oven door 16 is fully closed, it will contact the base member 84 so as to be in electrical contact therewith. Thus, electric current can be conducted between the first and second conductors 80, 82 only when the first conductor 80 is engaged with the second conductor 82, and when the actuator member 86 is in the second retracted position 90. Such a design can be beneficial to inhibit an end user from tampering with the electric current conduction system 78.

Though the first conductor (56, 74, 80) and the second conductor (58, 76, 82) are shown disposed generally towards the bottom of the oven door 16 in the various examples of FIGS. 4A-6B, it is to be appreciated that the conductors can be located at various other positions on the appliance 10. For example, as shown in FIG. 2, the conductors 56, 58 can be located generally towards an upper portion of the oven door 16 and chassis flange 54. In addition or alternatively, the conductors 56, 58 can even be integrated into the door hinges 52.

In the various electric current conduction systems 50, 72, 78 discussed above, the first and second contacts are generally of the make-and-break style that require physical contact for the transfer of electric current. However, it is contemplated that the present invention can also utilize first and second contacts that do not require physical contact for the transfer of electric current. In one example, another electric current conduction system (not shown) can transfer electric current via separate coils, a transformer, or the like. For example, the first contact can include a first coil, and the second contact can include a second coil, such that when the first and second coils are in close proximity, an electric current flowing through the first coil can induce a similar electric current in the second coil. Thus, when the oven door 16 is moved to the open position 24, the first and second coils would be separated by a sufficient distance to interrupt the flow of current therebetween.

The various electric conduction systems 50, 72, 78 are illustrated herein merely by way of example, and can be modified and adapted accordingly for use with various driven components, various appliances, etc. Accordingly, the various elements of the electric conduction systems 50, 72, 78 can have various geometries and can be disposed variously about the appliance. It is also to be appreciated that the electric conduction systems 50, 72, 78 can be used in settings other than in a range or oven. For example, the electric conduction systems 50, 72, 78 could be used in various appliances having a door, such as a refrigerator, freezer unit, icemaker, dishwasher, washing machine, dryer, or the like. Even further still, the electric conduction systems 50, 72, 78 can be utilized in various other applications, such as furniture, power tools, shelving, computer equipment, exercise equipment, equipment supports, commercial or industrial equipment, and/or various other applications where it may be desirable to power a driven component disposed on a door.

Additionally, the size and/or geometry of the various components of the electric conduction systems 50, 72, 78 can also depend upon the intended use of the system. For example, the size and/or geometry can be varied depending upon the type of appliance and/or the type of driven component it is intended to be used with. In the example embodiments, the electric conduction systems 50, 72, 78 are sized to power a light disposed on the door of a conventional oven. However, the various elements of the electric conduction systems 50, 72, 78 can be made larger or more numerous to fit commercial appliances (e.g., commercial ovens, refrigerators, freezer units, icemakers, dishwashers, washers, dryers, or the like), or sized to fit various other applications in which the electric conduction systems 50, 72, 78 are to be used. In one example, where multiple driven components are included on an oven door, multiple electric conduction systems 50, 72, 78 can be utilized to provide sufficient power, independent controls, or other desirable features. In the various scenarios, the size, geometry, and/or electric current conduction capacity of the electric conduction systems 50, 72, 78 can be adapted accordingly.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. An appliance having an electric current conduction system, including:
a main body portion including an interior cavity having an opening;
a door mounted for movement between an open position permitting access to the interior cavity and a closed position having the door extend across the opening, the door being at least partially bounded by an outer face;
a driven component coupled to the door and disposed at least partially exterior of the outer face; and
an electric current conduction system, including:
a first conductor connected to the main body; and
a second conductor connected to the door and configured to selectively engage the first conductor based upon the position of the door, electric current being conducted between the first and second conductors only when the first conductor is engaged with the second conductor,
the driven component being operatively connected to the second conductor such that electric current is conducted between the main body portion and the driven component for driving the driven component only when the first conductor is engaged with the second conductor.

2. The appliance of claim 1, wherein the first conductor is engaged with the second conductor only when the door is in the closed position.

3. The appliance of claim 1, wherein the driven component includes at least one light.

4. The appliance of claim 3, wherein the light is operatively connected to a sensor for at least partially controlling operation of the light.

5. The appliance of claim 4, wherein the sensor includes a proximity sensor for detecting the presence of a user near the appliance.

6. The appliance of claim 4, wherein the sensor includes a light sensor for detecting the intensity of ambient light near the appliance.

7. The appliance of claim 3, wherein the door includes a handle, the at least one light being mounted within the handle.

8. The appliance of claim 7, wherein door includes an upper portion and a lower portion, the handle being coupled to the door about the upper portion, the light being arranged within the handle so as to emit light directed generally towards the lower portion.

9. The appliance of claim 1, wherein the electric current conduction system further includes:
means for receiving electric current from a supply line at supply line voltage; and
means for reducing the voltage of the electric current received by the means for receiving to a voltage less than the supply line voltage, the reduced voltage electric current being conducted between the first and second conductors.

10. The appliance of claim 9, wherein the means for reducing the voltage of the electric current is configured to provide the reduced voltage electric current within the range of approximately 0 volts DC to approximately 50 volts DC.

11. The appliance of claim 9, wherein the means for reducing the voltage of the electric current is configured to provide the reduced voltage electric current within the range of approximately 0 volts AC to approximately 50 volts AC.

12. The appliance of claim 1, wherein at least one of the first and second conductors includes a base member and an actuator member, the actuator member being movable relative to the base member between a first position and a second position, electric current being conducted between the first and second conductors only when the first conductor is engaged with the second conductor and when the actuator member is in the second position.

13. The appliance of claim 1, wherein the electric current conduction system further includes a switch for selectively interrupting the conduction of electric current to the driven component.

14. An electric current conduction system for an appliance, the electric current conduction system including:
means for receiving electric current from a supply line at supply line voltage;
means for reducing the voltage of the electric current received by the means for receiving to a voltage less than the supply line voltage;
a driven component;
a first conductor configured to be coupled to a main body of an appliance and operatively connected to the means for reducing; and
a second conductor electrically connected to the driven component and configured to be coupled to a door of an appliance so as to selectively engage and disengage the first conductor based upon a position of the door, the reduced voltage electric current being conducted between the first conductor and the driven component only when the first conductor is engaged with the second conductor.

15. The electric current conduction system of claim 14, wherein the first conductor is configured to engage the second conductor only when the door is in a closed position relative to the main body of an appliance.

16. The electric current conduction system of claim 14, wherein the driven component includes at least one light.

17. The electric current conduction system of claim 16, wherein the light is coupled to a handle configured to be attached to a door.

18. The electric current conduction system of claim 14, wherein the means for reducing the voltage of the electric current is configured to provide the reduced voltage electric current within the range of approximately 0 volts DC to approximately 50 volts DC.

19. The electric current conduction system of claim 14, wherein the means for reducing the voltage of the electric current is configured to provide the reduced voltage electric current within the range of approximately 0 volts AC to approximately 50 volts AC.

20. The electric current conduction system of claim 14, wherein at least one of the first and second conductors includes a base member and an actuator member, the actuator member being movable relative to the base member between a first position and a second position, electric current being conducted between the first and second conductors only when the first conductor is engaged with the second conductor and when the actuator member is in the second position.

21. The electric current conduction system of claim 14, wherein the electric current conduction system further includes a switch for selectively interrupting the conduction of electric current to the driven component.

22. The electric current conduction system of claim 14, wherein the driven component is operatively connected to a sensor for at least partially controlling operation of the driven component.

23. The electric current conduction system of claim 23, wherein the sensor includes a proximity sensor for detecting the presence of a user near the appliance.

24. The electric current conduction system of claim 23, wherein the sensor includes a light sensor for detecting the intensity of ambient light near the appliance.

25. An appliance having an electric current conduction system, including:
a main body portion including an interior cavity having an opening;
a door mounted for movement between an open position permitting access to the interior cavity, and a closed position having the door extend across the opening;
a handle coupled to the door and at least partially disposed exterior of the door;
an electric current conduction system, including:
a first conductor connected to the main body; and
a second conductor connected to the door and configured to selectively engage and disengage the first conductor based upon the position of the door, electric current being conducted between the first and second conductors only when the first conductor is engaged with the second conductor; and
a light coupled to the handle and operatively connected to the second conductor for receiving electric current for driving the light.

26. The appliance of claim 25, wherein the first conductor is engaged with the second conductor only when the door is in the closed position.

27. The appliance of claim 25, wherein door includes an upper portion and a lower portion, the handle being coupled to the door about the upper portion, the light being arranged within the handle so as to emit light directed generally towards the lower portion.

28. The appliance of claim 25, wherein the electric current conduction system further includes:
means for receiving electric current from a supply line at supply line voltage; and
means for reducing the voltage of the electric current received by the means for receiving to a voltage less than the supply line voltage, the reduced voltage electric current being conducted between the first and second conductors.

29. The appliance of claim 25, wherein at least one of the first and second conductors includes a base member and an actuator member, the actuator member being movable relative to the base member between a first position and a second position, electric current being conducted between the first and second conductors only when the first conductor is engaged with the second conductor and when the actuator member is in the second position.

30. The appliance of claim 25, wherein the electric current conduction system further includes a switch for selectively interrupting the conduction of electric current to the light.

31. The appliance of claim 25, wherein the light is operatively connected to a sensor for at least partially controlling operation of the light.

32. The appliance of claim 32, wherein the sensor includes a proximity sensor for detecting the presence of a user near the appliance.

33. The appliance of claim 32, wherein the sensor includes a light sensor for detecting the intensity of ambient light near the appliance.
